(19) United States
(12) Patent Application Publication
(10) Pub. No.: US 2005/0003789 A1
(43) Pub. Date: Jan. 6, 2005

(54) Shield for high-frequency transmitter/receiver systems of electronic devices, especially of devices for wireless telecommunication

(76) Inventors: Georg Busch, Ahaus (DE); Volker Detering, Emmerich (DE)

Correspondence Address: BELL, BOYD & LLOYD, LLC, P. O. BOX 1135, CHICAGO, IL, 60690-1135, US

(21) Appl. No.: 10/472,656

(22) PCT Filed: Mar. 21, 2002
(86) PCT No.: PCT/DE02/01033

(30) Foreign Application Priority Data
Mar. 22, 2001 (DE) 101 14 110.6

(51) Int. Cl. H04B 1/06; H04B 7/00; H04B 1/28

(52) U.S. Cl. 455/300; 455/252.1; 455/333

(57) ABSTRACT

The invention relates to a shield for high-frequency transmitter/receiver systems of electronic devices, especially of devices for wireless telecommunication. In order to reduce the space requirements of such a high-frequency transmitter/receiver system (2′) on a circuit support element (1′) of an electronic device, a first partial circuit (20′) of the high-frequency transmitter/receiver system (2′) and a second partial circuit (21′) of the high-frequency transmitter/receiver system (2′) are disposed in a single shield chamber (32) in a substantially separate especially locally/partially separate manner. The shield chamber (32) is linked with a grounded area (10′) on the support element (1′) via an electroconducting connection (320) and the connecting element (320) is interposed between the two partial circuits (20′, 21′) on the support element (1′) in such a way that the twp partial circuits (20′, 21′) on the support element (1′) in such a way that the two partial (20′, 21′) do not interfere with each other functionally.

### BACKGROUND OF THE INVENTION

Electronic wireless telecommunications devices such as cordless telephones based on the DECT standard (Digital Enhanced Cordless Telecommunication) or mobile telephone handsets based on the GSM standard (Groupe Spéciale Mobile or Global System for Mobile Telecommunication) not only have circuits for signal processing in the low-frequency baseband but also have radio-frequency transceivers. These circuits and RF devices are usually mounted on a substrate, the so-called circuit board, in numerous process engineering and component insertion operations. In the course of electronic device miniaturization, films rather than circuit boards are increasingly being used as substrates.

FIG. 1 shows, from known prior art, a substrate 1 with a ground plane 10 on which there is disposed a radio-frequency transceiver 2 connected to a wire antenna 3, which is likewise disposed on the substrate 1. The radio-frequency transceiver 2 contains two sub-circuits 20, 21; a first sub-circuit 20 having, for example, an output power amplifier 200, and a second sub-circuit 21 having, for example, oscillators 210 and synthesizers 211. The two sub-circuits 20, 21, in a certain spatial arrangement, tend to produce mutual interference in respect of the RF fields but must not interfere with one another in terms of their respective functions. Radiated interference and interference from the environment likewise must be prevented. This scenario is schematically indicated in FIG. 1 by the arrows. The double-headed horizontal and vertical arrows indicate the electromagnetic fields emitted by the sub-circuits 20, 21 which affect the sub-circuits 20, 21. The three-dimensionally represented arrow indicates the phenomenon of crosstalk from the first sub-circuit 20 to the second sub-circuit 21, and vice versa. The remaining arrows indicate the presence of balancing currents in the substrate 1 and shielding chambers. In other words, the device must satisfy the requirements of internal and external electromagnetic compatibility (EMC).

To achieve this, the sub-circuits 20, 21 of the radio-frequency transceiver 2 on the substrate 1 are enclosed by at least two shielding chambers 30, 31 in such a way that the individual sub-circuits are completely shielded (i.e.,, RF-proof), a first shielding chamber 30 being used as self-contained shielding for the first sub-circuit 20, while a second shielding chamber 31 is used exclusively as shielding for the second sub-circuit 21. In accordance with this prior art, there are provided between the sub-circuits 20, 21 two continuous isolation barriers which prevent interference effects.

An object of the present invention is to reduce the space requirement for the shielding of the radio-frequency transceiver on a circuit substrate of an electronic device, particularly of wireless telecommunications equipment.

### SUMMARY OF THE INVENTION

The idea underlying the present invention is that there are disposed on a circuit substrate of an electronic device, under a single shielding chamber, a first sub-circuit of a radio-frequency transceiver and a second sub-circuit of the radio-frequency transceiver which are substantially (in particular, locally/spatially separate from one another. The shielding chamber is connected to a ground plane on the substrate via an electrically conductive connecting element and the conducting element is disposed between the two sub-circuits on the substrate in such a way that the two sub-circuits do not interfere functionally with one another.

Because of the space saved on the circuit substrate by not having a second shielding chamber, it is possible, for example, to implement smaller electronic devices with radio-frequency transceivers than ever before. For electronic devices for wireless telecommunications, this results in such devices being able to be incorporated, for example, in a wristwatch.

Additional features and advantages of the present invention are described in, and will be apparent from, the following Detailed Description of the Invention and the Figures.

### BRIEF DESCRIPTION OF THE FIGURES

FIG. 1 is a schematic perspective view of the structure of a radio frequency transceiver on a substrate with two shielding chambers as known in the prior art.

FIG. 2 based on FIG. 1 is a schematic perspective view of the structure of a radio-frequency transceiver on a substrate with a single shielding chamber in accordance with the present invention.

FIG. 3 is a cross-sectional view of FIG. 2 along the line A . . . A′.

### DETAILED DESCRIPTION OF THE INVENTION

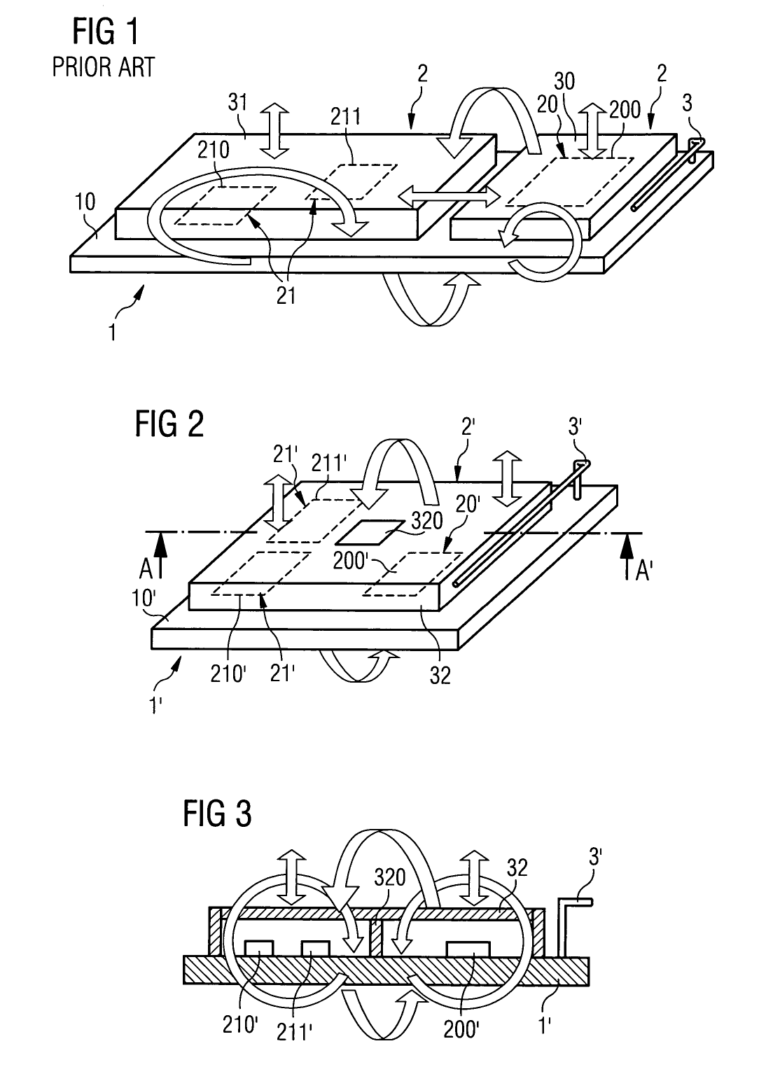

FIG. 2 shows a substrate 1′ with a ground plane 10′ on which there is disposed a radio-frequency transceiver 2′ which is connected to a wire antenna 3′, likewise disposed on the substrate 1′. The radio-frequency transceiver 2′ contains two sub-circuits 20′, 21′; a first sub-circuit 20′ having, for example, an output power amplifier 200′, and a second sub-circuit 21′ having, for example, oscillators 210′ and synthesizers 211′. The two sub-circuits 20, 21, in a certain spatial/local arrangement, tend to produce mutual interference in respect of the RF fields but must not interfere with one another in terms of their respective functions. Radiated interference and interference from the environment likewise must be prevented. This scenario is again schematically indicated in FIG. 1 by the arrows. The double-headed vertical arrows indicate the electromagnetic fields emitted by the sub-circuits 20′, 21′ which affect the sub-circuits 20′, 21′. The three-dimensionally represented arrow indicates the phenomenon of crosstalk from the first sub-circuit 20′ to the second sub-circuit 21′, and vice versa. The remaining arrows as per FIG. 3 indicate the presence of balancing currents in the substrate 1′ and shielding chambers. In other words, the device must satisfy the requirements of internal and external electromagnetic compatibility (EMC).

To achieve this, the sub-circuits 20′, 21′ of the radio-frequency transceiver 2′ on the substrate 1′ are, in contrast to the approach in FIG. 1, enclosed by a single shielding chamber 32 in such a way that the individual sub-circuits are completely shielded; i.e., so to speak, RF-proof. As the two sub-circuits 20′, 21′ are both completely enclosed by the shielding chamber, with no continuous isolation barrier being present between the sub-circuits 20′, 21′ in the prior art as illustrated in FIG. 1, mutual interference between the sub-circuits 20′, 21′ is prevented; particularly, the abovementioned crosstalk. The shielding chamber 32 must be further developed and/or the disposition of the sub-circuits under the shielding chamber must be optimized so as to ensure that this interference does not occur or is at least largely suppressed.

For this purpose, the shielding chamber 32 as shown in FIGS. 2 and 3 is connected to an electrically conductive connecting element 320 which preferably is a component, a spring or a dome-like structure made of the same material (preferably, nickel silver), as the shielding chamber 32. On the opposite side, this connecting element 320 is connected to the ground plane 10′ on the substrate 1′, thereby establishing an electrical connection from the cover of the shielding chamber 320 to the ground plane 10′. Currents required for the output power amplifier 200′ are derived via this connection (tapping). The currents of the output power amplifier 200′ are kept away from the oscillators 210′ and synthesizers 211′ via this connection.

To achieve this, the connecting element 320 is disposed between the two mutually interfering sub-circuits 20′, 21′ on the substrate 1′ in such a way that the two sub-circuits 20′, 21′ do no interfere with one another functionally. Disposed in this way, substantially the same shielding effect can be achieved with the connecting element 320 as with at least one isolation barrier according to the prior art. The connecting element 320, therefore, constitutes a fictitious isolation barrier for the two sub-circuits 20′, 21′, provided that these are substantially disposed (in particular, locally/spatially) separate from one another on the substrate 1′ under the shielding chamber 320.

Thus, in spite of the fictitious isolation barrier, the sub-circuits 20′, 21′ preferably should not be immediately adjacent or adjoining, as shown schematically in FIG. 3.

Although the present invention has been described with reference to specific embodiments, those of skill in the art will recognize that changes may be made thereto without departing from the spirit and scope of the present invention as set forth in the hereafter appended claims.

1. Shielding for radio-frequency transceivers of electronic devices, particularly of wireless telecommunications devices, having the following features:
(a) On a circuit substrate (1′) of the electronic device there are disposed under a single shielding chamber (32) a first sub-circuit (20′) of the radio-frequency transceiver (2′) and a second sub-circuit (21′) of the radio-frequency transceiver (2′) essentially separated from one another, in particular locally/spatially separated,
(b) the shielding chamber (32) is connected on the substrate (1′) to a ground plane (10′) via an electrically conductive connecting element (320),
(c) the connecting element (320) is disposed between the two sub-circuits (20′, 21′) on the substrate (1′) in such a way that the two sub-circuits (20′, 21′) do not interfere with one another functionally.

2. Shielding according to claim 1, wherein the connecting element (320) is an electrical component which can be inserted with the components of the sub-circuits (20′, 21′) on the substrate (1′).

3. Shielding according to claim 1, wherein the connecting element (320) is a spring.

4. Shielding according to claim 1, wherein the connecting element (320) is a dome-like structure.

5. Shielding according to claim 1 or 4, wherein the connecting element (320) and the shielding chamber (32) are made of the same material.

6. Shielding according to claim 5, wherein the material is low-impedance.

7. Shielding according to claim 5 or 6, wherein the material is nickel silver.
